(19) United States
(12) Patent Application Publication
(10) Pub. No.: US 2021/0256721 A1
(43) Pub. Date: Aug. 19, 2021

(54) METHOD AND APPARATUS FOR ENHANCING DISPARITY MAP

(71) Applicant: ELECTRONICS AND TELECOMMUNICATIONS RESEARCH INSTITUTE, Daejeon (KR)

(72) Inventors: Kap Kee KIM, Daejeon (KR); BonKi KOO, Daejeon (KR)

(21) Appl. No.: 17/151,939

(22) Filed: Jan. 19, 2021

(30) Foreign Application Priority Data
Feb. 12, 2020 (KR) 10-2020-0016764

(51) Int. Cl. G06T 7/593; G06T 5/50

(52) U.S. Cl. CPC G06T 7/593; G06T 2207/20021; G06T 2207/20228; G06T 5/50

(57) ABSTRACT

An apparatus for enhancing a disparity map generates a disparity map of a reference image by performing stereo matching for each stereo image, divides the reference image into at least one homogeneous area based on a homogeneity criterion, extracts valid disparity values from the disparity map of the reference image, calculates a linear rate of change for the valid disparity values in each homogeneous area divided based on the extracted valid disparity values, and enhances the disparity map by updating invalid disparity values in a corresponding homogeneous area using the linear rate of change calculated for each homogeneous area.

### CROSS-REFERENCE TO RELATED APPLICATION

This application claims priority to and the benefit of Korean Patent Application No. 10-2020-0016764 filed in the Korean Intellectual Property Office on Feb. 12, 2020, the entire content of which is incorporated herein by reference.

### BACKGROUND OF THE INVENTION

### 1. Field of the Invention

The present invention relates to a method and apparatus for enhancing a disparity map, and more particularly, to a method and apparatus for enhancing a disparity map for improving disparity errors of a disparity map according to matching of stereo images.

### 2. Description of Related Art

The stereo matching result is output as a disparity map. The disparity map is an image in which a position difference value between each pixel of a reference image and a corresponding pixel of a reference image is displayed in coordinates of the reference image.

There are various stereo matching methods, but the matching result is not perfect, so the disparity map correction is required as a post-processing operation. The disparity errors occur due to the limitation of the stereo matching algorithm, or also occur due to the image acquired from the camera itself. For example, the disparity error due to the former case may occur when the object is visible only in one image due to the difference between the baseline and the camera rotation in the left and right images, and the disparity error due to the latter case may occur when the object is in both the left and right images, but the pixel contrast or color value between the left and right images are different. Due to these disparity errors, an invalid disparity value is generated, so the reliability of the stereo matching result is decreased.

A method of enhancing the errors by using the peripheral disparity values of the disparity map is used as a conventional method to solve this problem.

### SUMMARY OF THE INVENTION

The present invention has been made in an effort to provide a disparity map capable of improving the reliability of a disparity map stereo matching result.

According to an embodiment of the present invention, a method for enhancing a disparity map generated by performing stereo matching on a stereo image in an apparatus for enhancing the disparity map is provided. The method for enhancing a disparity map includes: generating a disparity map of a reference image by performing stereo matching for each stereo image; dividing the reference image into at least one homogeneous area based on a homogeneity criterion; extracting valid disparity values from the disparity map of the reference image; calculating a linear rate of change for the valid disparity values in each homogeneous area divided based on the extracted valid disparity values; and enhancing the disparity map by updating invalid disparity values in a corresponding homogeneous area using the linear rate of change calculated for each homogeneous area.

The calculating includes: a first step of setting a linear rate of change in a first homogeneous area by using valid disparity values in the first homogeneous area, when the number of valid disparity values in the first homogeneous area is greater than a minimum value; and a second step of setting a linear rate of change in the first homogeneous area by using the valid disparity values of at least one second homogeneous area adjacent to the first homogeneous area, when the number of valid disparity values in the first homogeneous area is less than or equal to the minimum value.

The first step includes, when there are two or more pixels having a valid disparity value on the same y-axis in the first homogeneous area, calculating the linear rate of change using the two valid disparity values, and the enhancing includes updating an invalid disparity value existing on a line connecting the coordinates of the two pixels having the valid disparity values using the linear rate of change and the valid disparity values.

The first step includes, when there is one pixel having a valid disparity value on the same y-axis in the first homogeneous area, calculating the linear rate of change using the valid disparity value of the one pixel and a valid disparity value of a pixel closest to the one pixel, and the enhancing includes updating an invalid disparity value existing on a line connecting coordinates of two pixels having the valid disparity values using the linear rate of change and the valid disparity value of the one pixel.

The second step includes, when two pixels having the same y-axis coordinate value in two second homogeneous areas have a valid pixel value, respectively, and there is one pixel having a valid disparity value in the first homogeneous area: estimating disparity values of two pixels in the first homogeneous area having the same y-axis coordinate value as the two pixels of the two second homogeneous areas using a linear rate of change with respect to the valid pixel values of the two pixels of the two second homogeneous areas; and calculating a linear rate of change in the first homogeneous area by using the distance between each pixel with the estimated disparity value in the first homogeneous area and the pixel having the valid disparity value in the first homogeneous area.

The second step includes, when one pixel has a valid disparity value on the y-axis in one second homogeneous area and one pixel has a valid disparity value in the first homogeneous area: estimating valid disparity values of two pixels of the first homogeneous area having the same y-axis coordinate value as the one pixel in the one second homogeneous area using by using a linear rate of change of the valid disparity value in the one second homogeneous area; and calculating a linear rate of change in the first homogeneous area by using the distance between each pixel with the estimated disparity value in the first homogeneous area and the pixel having the valid disparity value in the first homogeneous area.

The enhancing includes updating the invalid disparity values in the first homogeneous area by using a linear rate of change in the first homogeneous area and a valid disparity value in the first homogeneous area.

The second step includes, when two pixels having the same y-axis coordinate value in two second homogeneous areas have a valid pixel value, respectively, and there is no pixel having a valid disparity value in the first homogeneous area: estimating disparity values of two pixels in the first homogeneous area having the same y-axis coordinate value with the two pixels of the two second homogeneous areas using a linear rate of change with respect to the valid pixel values of the two pixels of the two second homogeneous areas; and calculating a linear rate of change in the first homogeneous area by using the estimated disparity values of two pixels in the first homogeneous area.

The second step includes, when one pixel has a valid disparity value on the y-axis in one second homogeneous area, and there is no pixel having a valid disparity value in the first homogeneous area: estimating valid disparity values of two pixels of the first homogeneous area having the same y-axis coordinate value as the one pixel in the one second homogeneous area using by using a linear rate of change of the valid disparity value in the one second homogeneous area; and calculating a linear rate of change in the first homogeneous area by using the estimated disparity values of two pixels in the first homogeneous area.

The enhancing includes updating an invalid disparity value in the first homogeneous region by using a linear rate of change in the first homogeneous region and a disparity value of two pixels estimated in the first homogeneous region.

The dividing includes grouping pixels having homogeneity in at least one of brightness, texture, and color of the pixel into the same homogeneous area.

The enhancing includes, after updating the invalid disparity values for all homogeneous areas in the reference image, smoothing an updated disparity map.

According to another embodiment of the present invention, an apparatus for enhancing a disparity map generated from a stereo image is provided. The apparatus for enhancing a disparity map includes: a stereo matching unit that performs stereo matching for each input stereo image to generate a disparity map of a reference image; and a disparity enhancing unit that divides the reference image into at least one homogeneous area based on a homogeneity criterion, extracts valid disparity values from the disparity map of the reference image, and updates invalid disparity values in a corresponding homogeneous area by calculating a linear rate of change for the valid disparity values in each divided homogeneous area.

The disparity enhancing unit includes a disparity allocator for setting a linear rate of change for valid disparity values of the first homogeneous area by using at least one valid disparity value in the first homogeneous area, or by using the valid disparity values of at least one second homogeneous area adjacent to the first homogeneous area, based on the number of valid disparity values in the first homogeneous area.

The disparity allocator updates invalid disparity values existing in the first homogeneous area by using the linear rate of change for valid disparity values of the first homogeneous area and the at least one valid disparity value in the first homogeneous area.

The disparity allocator updates estimating disparity values of two pixels in the first homogeneous area having the same y-axis coordinate value as at least one pixel having a valid disparity value of the second homogeneous areas using a linear rate of change with respect to the at least one valid pixel value of the second homogeneous areas, and calculates a linear rate of change in the first homogeneous area by using the estimated disparity values of two pixels in the first homogeneous area.

When there is one pixel having a valid disparity value in the first homogeneous area, the disparity allocator calculates the linear rate of change in the first homogeneous area by using the estimated disparity values of two pixels in the first homogeneous area and the valid disparity value of the one pixel of the first homogeneous area.

The disparity allocator updates the invalid disparity values in the first homogeneous area by using the linear rate of change in the first homogeneous area and the estimated disparity values of two pixels in the first homogeneous area.

The disparity enhancing unit smooths an updated disparity map after updating the invalid disparity values for all homogeneous areas in the reference image.

The disparity enhancing unit includes an image divider for grouping pixels having homogeneity in at least one of brightness, texture, and color of the pixel into the same homogeneous area.

### BRIEF DESCRIPTION OF THE DRAWINGS

FIG. 1 is diagram illustrating an apparatus for enhancing a disparity map according to an embodiment of the present invention.

FIG. 2 is a diagram illustrating a method of extracting a valid disparity value according to an embodiment of the present invention.

FIG. 3 is a flowchart illustrating a method of updating an invalid disparity value in the disparity allocator illustrated in FIG. 1.

FIG. 4 and FIG. 5 are diagrams for explaining a method of updating an invalid disparity using an internal linear relationship in an ROI, respectively.

FIG. 6 to FIG. 9 are diagrams for explaining a method of updating an invalid disparity using an external linear relationship in an ROI, respectively.

FIG. 10 is a diagram for illustrating an apparatus for enhancing a disparity map according to another embodiment of the present invention.

### DETAILED DESCRIPTION OF THE EMBODIMENTS

Hereinafter, embodiments of the present invention will be described in detail with reference to the attached drawings so that a person of ordinary skill in the art may easily implement the present invention. The present invention may be modified in various ways, and is not limited thereto. In the drawings, elements that are irrelevant to the description of the present invention are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Hereinafter, a method and apparatus for enhancing a disparity map according to embodiments of the present invention will be described in detail with reference to the accompanying drawings.

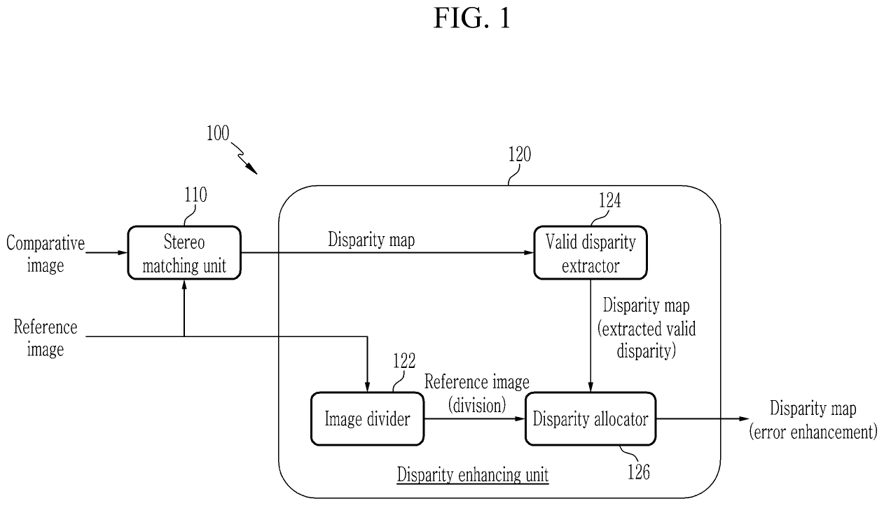

FIG. 1 is diagram illustrating an apparatus for enhancing a disparity map according to an embodiment of the present invention.

Referring to FIG. 1, an apparatus for enhancing a disparity map 100 includes a stereo matching unit 110 and a disparity enhancing unit 120.

The stereo matching unit 110 performs stereo matching on the stereo image to obtain the disparity of the reference image and the comparative image, and displays the obtained disparity on the coordinates of the corresponding image, respectively, to generate a disparity map of the reference image and a disparity map of the comparative image. Stereo matching is the process of finding corresponding points in the comparative image (e.g., the right image) for each pixel in the reference image (e.g., the left image) in the stereo image. The stereo matching disparity process is to calculate disparity values indicating how far the corresponding pixels are from each other in the reference image and the comparative image. For example, if the disparity value of the pixel at the (x, y) position calculated through stereo matching on the left image, which is the reference image, is D_{L}(x, y), a pixel at a position (x-(D_{L}(x, y),y) separated by a pixel distance of D_{L}(x, y) based on the (x, y) position in the right image, which is the comparative image, becomes a corresponding point with a pixel at the (x, y) position of the left image.

Meanwhile, image rectification may be performed through image pre-processing before stereo matching. The image rectification is to align the y-axis of the image using external and internal parameters of the camera. The stereo matching is to find a point corresponding to a point of reference image in the comparative image. If the image rectification is performed, the entire image is not searched for finding the point corresponding to a point of reference image, but only on the same y-axis, is searched.

The disparity enhancing unit 120 enhances disparity errors of the disparity map generated by the stereo matching unit 110.

The disparity enhancing unit 120 includes an image divider 122, a valid disparity extractor 124, and a disparity allocator 126. Hereinafter, for convenience of explanation, an embodiment of enhancing the disparity map of the left image will be described, and the method for enhancing the disparity map of the left image described below may be applied for enhancing the disparity map of the right image.

The image divider 122 divides the reference image, which is an input image of the disparity map, into at least one homogeneous area based on homogeneity. The homogeneous area refers to a set of pixels having homogeneity such as brightness, texture, and color of a pixel. The image divider 122 may divide the image into at least one homogeneous region using, for example, a superpixel technique. The superpixel technique is a method of collecting pixels with similar characteristics and dividing the image into small areas. At this time, the number of divisions may vary depending on the size of the image and the complexity of the captured scene, and one homogeneous region is represented as one divided area.

The valid disparity extractor 124 extracts valid disparity values from the disparity map and displays them on the disparity map. As a method of extracting valid disparity values, a method of comparing disparity value differences between corresponding points between the left image and the right image and a set threshold value may be used.

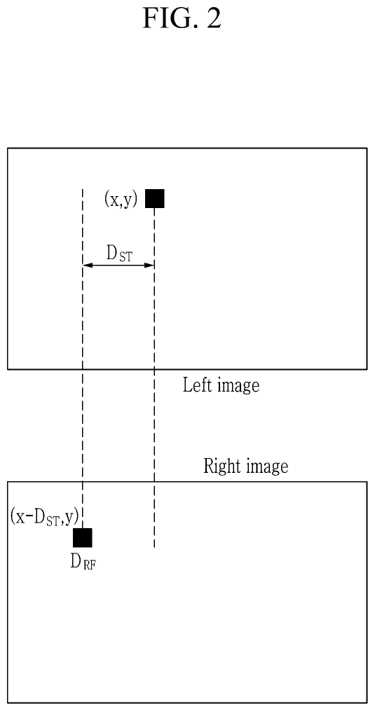

FIG. 2 is a diagram illustrating a method of extracting a valid disparity value according to an embodiment of the present invention.

As shown in FIG. 2, if the disparity value of one pixel at the (x, y) position in the left image is D_{ST}, then the pixel separated by the D_{ST} pixels from the pixel at the (x, y) position in the right image is a corresponding point in the right image for the pixel at the (x, y) position in the left image. Furthermore, when the disparity value of the pixel (x-D_{ST}, y) separated by the D_{ST} pixels from the pixel at the (x, y) position in the right image is D_{RF}, and D_{ST} equals D_{RF}, it can be seen that the disparity values of the corresponding points between the left and right images are consistent. At this time, the disparity value of the pixel at the (x, y) position in the left image corresponds to the valid disparity.

As shown in Equation 1, when the disparity difference value of the corresponding points between the left image and the right image with respect to the disparity value of one pixel at the (x, y) position in the left image is less than the threshold value, the valid disparity extractor 124 determines the disparity value of one pixel at the (x, y) position in the left image as a valid disparity, otherwise determines the disparity value of one pixel at the (x, y) position in the left image as an invalid disparity.

|d_{ST}−d_{RF}|<th_{d} (Equation 1)

In Equation 1, the D_{ST} represents the disparity value for the pixel at the (x, y) position in the left image, and the D_{RF} represents the disparity value for the pixel at the (x−D_{ST}, y) position in the right image. The th_{d} represents the threshold value.

Again referring to FIG. 1, the disparity allocator 126 sets an internal linear relationship and an external linear relationship for each divided area based on the valid disparity value extracted by the valid disparity extractor 124, updates an invalid disparity value, and performs smoothing processing. That is, the disparity allocator 126 updates the invalid disparity value in the homogeneous area based on the fact that the change of the valid disparity values in the homogeneous area has a linear relationship.

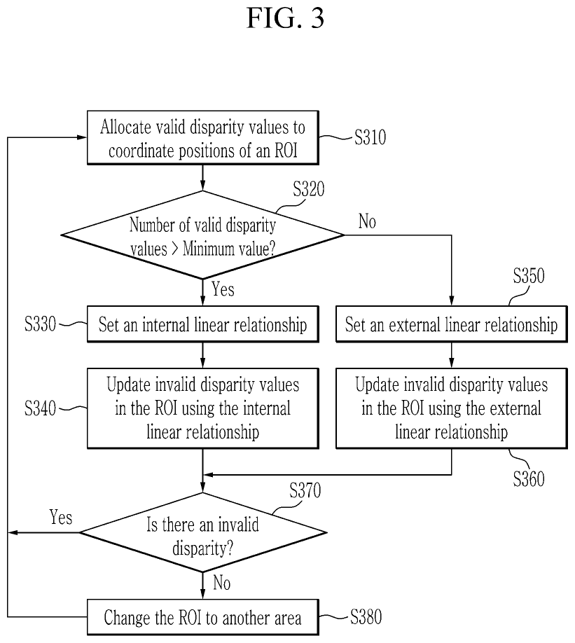

FIG. 3 is a flowchart illustrating a method of updating an invalid disparity value in the disparity allocator illustrated in FIG. 1.

Referring to FIG. 3, the disparity allocator 126 allocates valid disparity values to coordinate positions of a divided area [hereinafter, referred to as a region of interest (ROI)] of the left image, and checks the position and the number of the valid disparity values in the ROI of the left image (S310).

If the number of valid disparity values in the ROI is greater than a predetermined minimum value (S320), the disparity allocator 126 sets an internal linear relationship for the valid disparity value by using the valid disparity values inside the ROI (S330), and updates invalid disparity values in the ROI using the internal linear relationship (S340).

If the number of valid disparity values in the ROI is less than or equal to the predetermined minimum value (S320), the disparity allocator 126 sets an external linear relationship for the valid disparity value in the ROI by using valid disparity values of the area adjacent to the ROI (S350), and updates invalid disparity values in the ROI using the external linear relationship (S360).

The disparity allocator 126 checks whether there is an invalid disparity in the ROI (S370), and repeats steps S310 to S360 until there is no invalid disparity in the ROI.

If there is no invalid disparity in the ROI, the disparity allocator 126 changes the ROI to another divided area (380), and repeats steps S310 to S370.

In this way, invalid disparity values are updated for all divided areas in the left image.

After the disparity allocator 126 updates invalid disparity values in all divided areas in the left image, the disparity map is smoothed by applying a smoothing filter to the updated disparity map. In this case, the size of the filter and the number of times the filter is applied may be determined according to the utilization direction of the disparity map.

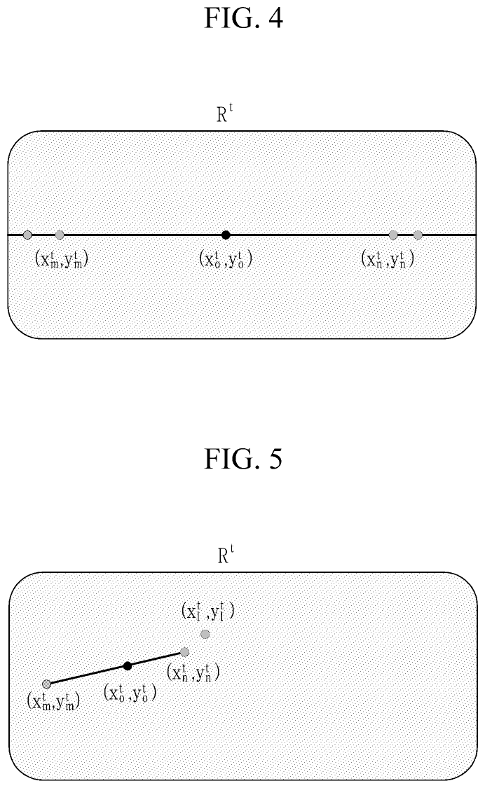

Next, a method of setting an internal linear relationship and updating invalid disparity values in the ROI using the internal linear relationship will be described in detail with reference to FIGS. 4 and 5.

FIG. 4 and FIG. 5 are diagrams for explaining a method of updating an invalid disparity using an internal linear relationship in an ROI, respectively.

The disparity allocator 126 calculates a linear rate of change (in the x-axis direction and the y-axis direction) of the valid disparity value by using two valid disparity values within the ROI of the left image, and updates invalid disparity values by applying the linear rate of change to the invalid disparity values. To explain more specifically, when the number of valid disparity values in the t-th ROI (R^{t}) is nₜ, it is expressed as (Rₜ:nₜ), and the coordinate set of the valid disparity values in the t-th ROI (R^{t}) is expressed as (Rₜ: nₜ)=((x₁^{t}, y₁^{t}), (x₂^{t}, y₂^{t}), . . . , (xₙ^{t}, yₙ^{t})}. “pixel (xₙ^{t}, yₙ^{t})” refers to a pixel at a position of the (xₙ^{t}, yₙ^{t}) coordinates.

As shown in FIG. 4, when there are two or more pixels having the valid disparity values on the same y-axis in the ROI (R^{t}), the coordinates of the pixels having two valid disparity values are connected with a line, and then the linear rate of change (Δd^{t}) of the valid disparity values is calculated. That is, when the two valid disparity values are d_{X}_{ₙ}^{t} and d_{X}_{ₘ}^{t}, and the coordinates of these two pixels are (xₙ^{t}, yₙ^{t}) and (xₘ^{t}, yₘ^{t}) since yₙ^{t} equals yₘ^{t}, the linear rate of change (Δd^{t}) of the two valid disparity values can be calculated as in Equation 2.

$$Δ {d}^{t} = \frac{{d}_{{x}_{m}}^{t} - {d}_{{x}_{n}}^{t}}{{x}_{m}^{t} - {x}_{n}^{t}} \qquad ( Equation 2 )$$

When a pixel (xₒ^{t}, yₒ^{t}) having an invalid disparity value exists on this line, the disparity allocator 126 updates the disparity value of the pixel (xₒ^{t}, yₒ^{t}) by using the linear rate of change (Δd^{t}) as in Equation 3.

dₓ_{ₒ}^{t}=(xₘ^{t}−xₒ^{t})*Δd^{t}+dₓ_{ₘ}^{t},(yₘ^{t}=yₒ^{t}) (Equation 3)

On the other hand, as shown in FIG. 5, when there is only one pixel having a valid disparity value in the same y-axis in the ROI (R^{t}), the coordinates (xₘ^{t}, yₘ^{t}) of the pixel and the coordinates (xₙ^{t}, yₙ^{t}) of the pixel having the valid disparity value closest to the pixel (xₘ^{t}, yₘ^{t}) are connected with a line, the linear rate of change (Δd^{t}) of the valid disparity value is calculated as shown in Equation 4.

$$Δ {d}^{t} = \frac{{d}_{{x}_{m}}^{t} - {d}_{{x}_{n}}^{t}}{\sqrt{{( {x}_{m}^{t} - {x}_{n}^{t} )}^{2} + {( {y}_{m}^{t} - {y}_{n}^{t} )}^{2}}} \qquad ( Equation 4 )$$

Here, the d_{X}_{ₘ}^{t} represents the valid disparity value of the position of the coordinate (xₘ^{t}, yₘ^{t}), and the d_{X}_{ₙ}^{t} represents the valid disparity value of the position of the coordinate (xₙ^{t}, yₙ^{t}).

If there is a pixel (xₒ^{t}, yₒ^{t}) having an invalid disparity on the line to which the two coordinates [(xₘ^{t}, yₘ^{t}), (xₙ^{t}, yₙ^{t})] are connected, the disparity allocator 126 updates the disparity value of the pixel (xₒ^{t}, yₒ^{t}) using the linear rate of change (Δd^{t}) of Equation 4, as shown in Equation 5.

d_{X}_{ₒ}^{t}=(\sqrt{(xₘ^{t}−xₒ^{t})²+(yₘ^{t}−yₒ^{t})²})*Δd^{t}+d_{X}_{ₘ}^{t} (Equation 5)

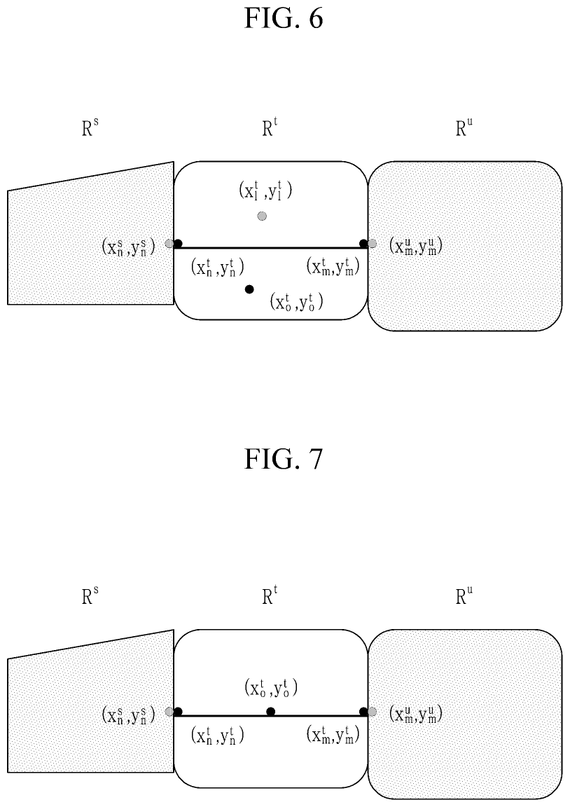

Next, a method of setting an external linear relationship and updating an invalid disparity in the ROI by using the external linear relationship will be described in detail with reference to FIGS. 6 to 9.

FIG. 6 to FIG. 9 are diagrams for explaining a method of updating an invalid disparity using an external linear relationship in an ROI, respectively.

When the number of valid disparity values in the ROI is less than the predetermined minimum value, the disparity allocator 126 updates the invalid disparity value of the ROI by using a linear rate of change of the valid disparity values of the area adjacent to the ROI. Here, the linear rate of change of the adjacent area of the ROI is referred to as the external linear rate of change of the ROI.

As shown in FIG. 6, when there are pixels [R^{s}:(xₙ^{s}, yₙ^{s}), R^{u}:(xₘ^{u}, yₘ^{u})] having a valid disparity value with the same y-axis coordinate value in adjacent areas (R^{s}, R^{u}) of the ROI (R^{t}), respectively, and there is one pixel (xₗ^{t}, yₗ^{t}) having a valid disparity value inside the ROI (R^{t}), the disparity allocator 126 calculates external linear rates of change (Δd^{s}, Δd^{u}) for the valid disparity values of the adjacent areas (R^{s}, R^{u}), respectively. When there is a pixel of a valid disparity value having the same y-axis coordinate value as the pixel (xₙ^{s}, yₙ^{s}) in the ROI (R^{t}), the external linear rate of change (Δd^{s}) can be calculated based on the linear relationship between the pixel (xₙ^{s}, yₙ^{s}) and the pixel in the ROI (R^{t}). Similarly, when there is a pixel of a valid disparity value having the same y-axis coordinate value with the pixel (xₘ^{u}, yₘ^{u}) in the ROI (R^{t}), the external linear rate of change (Δd^{u}) can be calculated based on the linear relationship between the pixel (xₘ^{u}, yₘ^{u}) and the pixel in the ROI (R^{t}).

The disparity allocator 126 estimates disparity values (d_{X}_{ₙ}^{t}, d_{X}_{ₘ}^{t}) of two pixels [(xₙ^{t}, yₙ^{t}), (xₘ^{t}, yₘ^{t})] that are immediately adjacent to two pixels [R^{s}:(xₙ^{s}, yₙ^{s}), R^{u}:(xₘ^{u}, yₘ^{u})] of adjacent areas, respectively, and have the same y-axis coordinate values as the two pixels [R^{s}:(xₙ^{s}, yₙ^{s}), R^{u}:(xₘ^{u}, yₘ^{u})], in the ROI (R^{t}), using the external linear rates of change (Δd^{s}, Δd^{u}), and sets the internal linear rate of change (Δd^{t}) of the ROI (R^{t}) using the distance between each pixel [(xₙ^{t}, yₙ^{t}), (xₘ^{t}, yₘ^{t})] estimated the disparity values (d_{X}_{ₙ}^{t}, d_{X}_{ₘ}^{t}) and the one pixel (xₗ^{t}, yₗ^{t}) having a valid disparity value in the ROI (R^{t}). At this time, the disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}) may be estimated as in Equations 6 and 7, respectively.

d_{X}_{ₙ}^{t}=(xₙ^{t}−xₙ^{s})*Δd^{S}+d_{X}_{ₙ}^{s} (Equation 6)

Here, Δd^{s} represents the linear rate of change of the valid disparity values of the adjacent area (R^{s}), that is, the external linear rate of change.

d_{X}_{ₘ}^{t}=(xₘ^{u}−xₘ^{t})*Δd^{u}+d_{X}_{ₙ}^{u} (Equation 7)

Here, Δd^{u} represents the linear rate of change of the valid disparity values of the adjacent area (R^{u}).

The internal linear rate of change (Δd^{t}) of the ROI (R^{t}) can be calculated as in Equation 8.

$$Δ {d}^{t} = \frac{Δ {d}_{ln}^{t} + Δ {d}_{lm}^{t}}{2} \qquad ( Equation 8 )$$

Here, Δdₗₙ^{t} represents the rate of change of the disparity values between xₙ and xₗ in the ROI (R^{t}), and may be calculated as in Equation 9. Δdₗₘ^{t} represents the rate of change of the disparity values between xₘ and xₗ in the ROI (R^{t}), and can be calculated as in Equation 10.

$$\begin{matrix}Δ {d}_{ln}^{t} = \frac{{d}_{{x}_{l}}^{t} - {d}_{{x}_{n}}^{t}}{\sqrt{{( {x}_{l}^{t} - {x}_{n}^{t} )}^{2} + {( {y}_{l}^{t} - {y}_{n}^{t} )}^{2}}} & ( Equation 9 ) \\ Δ {d}_{lm}^{t} = \frac{{d}_{{x}_{l}}^{t} - {d}_{{x}_{m}}^{t}}{\sqrt{{( {x}_{l}^{t} - {x}_{m}^{t} )}^{2} + {( {y}_{l}^{t} - {y}_{m}^{t} )}^{2}}} & ( Equation 10 )\end{matrix}$$

The disparity allocator 126 updates a disparity value of the pixel (xₒ^{t}, yₒ^{t}) having an invalid disparity value in the ROI (R^{t}) using the calculated internal linear rate of change (Δd^{t}) of the ROI (R^{t}) and the valid disparity value (dₓ_{ₗ}^{t}) in the ROI (R^{t}), as shown in Equation 11.

d_{X}_{ₒ}^{t}=(\sqrt{(xₗ^{t}−xₒ^{t})²+(yₗ^{t}−yₒ^{t})²})*Δd^{t}+d_{X}_{ₗ}^{t} (Equation 11)

Next, as shown in FIG. 7, when there are pixels [R^{s}:(xₙ^{s}, yₙ^{s}), R^{u}:(xₘ^{u}, yₘ^{u})] having a valid disparity value with the same y-axis coordinate value in adjacent areas (R^{s}, R^{u}) of the ROI (R^{t}), respectively, and there is no pixel with a valid disparity value in the ROI (R^{t}), the disparity allocator 126 calculates external linear rates of change (Δd^{s}, Δd^{u}) for the valid disparity values of the adjacent areas (R^{s}, R^{u}), respectively.

The disparity allocator 126 estimates disparity values (d_{X}_{ₙ}^{t}, d_{X}_{ₘ}^{t}) of two pixels [(xₙ^{t}, yₙ^{t}), (xₘ^{t}, yₘ^{t})] that are immediately adjacent to two pixels [R^{s}:(xₙ^{s}, yₙ^{s}), R^{u}: (xₘ^{u}, yₘ^{u})] of adjacent areas, respectively and have the same y-axis coordinate values as the two pixels [R^{s}:(xₙ^{s}, yₙ^{s}), R^{u}:(xₘ^{u}, yₘ^{u})], in the ROI (R^{t}), and sets the internal linear rate of change (Δd^{t}) of the ROI (R^{t}) using the estimated disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}), as shown in Equation 12. In this case, the disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}) may be estimated as in Equations 6 and 7.

$$Δ {d}^{t} = \frac{{d}_{{x}_{m}}^{t} - {d}_{{x}_{n}}^{t}}{{x}_{m}^{t} - {x}_{n}^{t}} \qquad ( Equation 12 )$$

In this case, the disparity allocator 126 updates a disparity value of the pixel (xₒ^{t}, yₒ^{t}) having an invalid disparity value in the ROI (R^{t}) using the calculated internal linear rate of change (Δd^{t}) of the ROI (R^{t}) and the estimated disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}), as shown in Equation 13.

d_{X}_{ₒ}^{t}=(xₙ^{t}−xₒ^{t})*Δd^{t}+d_{X}_{ₙ}^{t},(yₙ^{t}=yₘ^{t}=yₒ^{t}) (Equation 13)

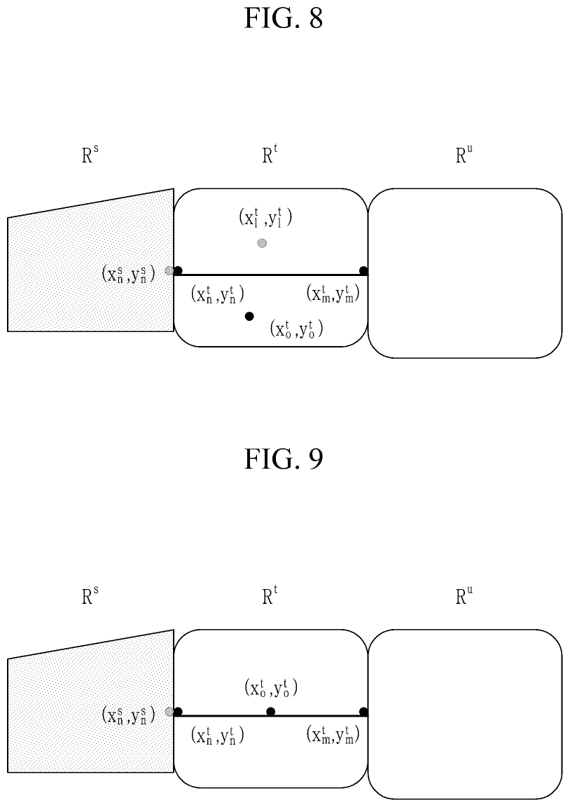

On the other hand, as shown in FIG. 8, when there is one pixel [R^{s}:(xₙ^{s}, yₙ^{s})] having a valid disparity value with the same y-axis coordinate value in adjacent areas (R^{s}, R^{u}) of the ROI (R^{t}), and there is one pixel (xₗ^{t}, yₗ^{t}) having a valid disparity value inside the ROI (R^{t}), the disparity allocator 126 estimates disparity values) (d_{X}_{ₙ}^{t}, d_{X}_{ₘ}^{t}) of two pixels [(xₙ^{t}, yₙ^{t}), (xₘ^{t}, yₘ^{t})] that are immediately adjacent to the adjacent areas (R^{s}, R^{u}), respectively, and have the same y-axis coordinate values as the pixels [R^{s}:(xₙ^{s}, yₙ^{s})] of the adjacent area (R^{s}), in the ROI (R^{t}), using the external linear rates of change (Δd^{s}). Then, the disparity allocator 126 sets the internal linear rate of change (Δd^{t}) of the ROI (R^{t}) using the distance between each pixel [(xₙ^{t}, yₙ^{t}), (xₘ^{t}, yₘ^{t})] in the ROI (R^{t}) and the one pixel (xₗ^{t}, yₗ^{t}) having a valid disparity value in the ROI (R^{t}), as shown in Equation 8. At this time, since the y-axis coordinate values of the two pixels [(xₙ^{t}, yₙ^{t}), (xₘ^{t}, yₘ^{t})] are the same, only the coordinate values of the x-axis need to be calculated, and the coordinate values of the x-axis may be calculated using the valid disparity value of the adjacent area (R^{s}) with the linear rates of change (Δd^{s}). The disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}) may be estimated as in Equations 14 and 15, respectively.

d_{X}_{ₙ}^{t}=(xₙ^{t}−xₙ^{s})*Δd^{S}+d_{X}_{ₙ}^{s} (Equation 14)

d_{X}_{ₘ}^{t}=(xₘ^{t}−xₙ^{s})*Δd^{s}+d_{X}_{ₙ}^{s} (Equation 15)

The disparity allocator 126 updates a disparity value of the pixel (xₒ^{t}, yₒ^{t}) having an invalid disparity value in the ROI (R^{t}) using the calculated internal linear rate of change (Δd^{t}) of the ROI (R^{t}) and the valid disparity value (d_{X}_{ₗ}^{t}) in the ROI (R^{t}), as shown in Equation 11.

In addition, as shown in FIG. 9, when there is one pixel [R^{s}:(xₙ^{s}, yₙ^{s})] having a valid disparity value with the same y-axis coordinate value in adjacent areas (R^{s}, R^{u}) of the ROI (R^{t}), and there is no pixel with a valid disparity value in the ROI (R^{t}), the disparity allocator 126 estimates disparity values (d_{X}_{ₙ}^{t}, d_{X}_{ₘ}^{t}) of two pixels [(xₙ^{t}, yₙ^{t}), (xₘ^{t}, yₘ^{t})] that are immediately adjacent to the adjacent areas (R^{s}, R^{u}), respectively, and have the same y-axis coordinate values as the pixels [R^{s}:(xₙ^{s}, yₙ^{s})] of the adjacent area (R^{s}), in the ROI (R^{t}), using the external linear rates of change (Δd^{s}). Then, the disparity allocator 126 sets the internal linear rate of change (Δd^{t}) of the ROI (R^{t}) using the estimated disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}), as shown in Equation 12. At this time, the disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}) may be estimated as in Equations 14 and 15, respectively.

In this case, the disparity allocator 126 updates a disparity value of the pixel (xₒ^{t}, yₒ^{t}) having an invalid disparity value in the ROI (R^{t}) using the calculated internal linear rate of change (Δd^{t}) of the ROI (R^{t}) and the estimated disparity values (d_{X}_{ₙ}^{t}, d_{X}_{ₘ}^{t}) of the two pixels [(xₙ^{t}, yₙ^{t}), (xₘ^{t}, yₘ^{t})] in the ROI (R^{t}), as shown in Equation 13.

After the disparity allocator 126 updates invalid disparity values in all divided areas in the left image, the disparity map is smoothed by applying a smoothing filter to the updated disparity map.

The method for enhancing the disparity map according to an embodiment of the present invention described above may correct the disparity map generated from the first input image by using the peripheral valid disparity values.

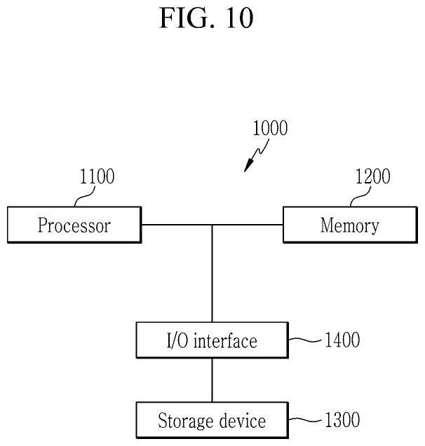

At least some functions of the method and apparatus for enhancing the disparity map may be implemented by hardware or by software coupled to hardware. Hereinafter, an embodiment in which a method and apparatus for enhancing a disparity map are combined with a computer system will be described in detail with reference to FIG. 10.

FIG. 10 is a diagram illustrating an apparatus for enhancing a disparity map according to another embodiment of the present invention, and represents a system that can be used to perform at least some of the functions of the apparatus for enhancing the disparity map 100 described with reference to FIGS. 1 to 9.

Referring to FIG. 10, the apparatus for enhancing a disparity map 1000 includes a processor 1100, a memory 1200, a storage device 1300, and an input/output (I/O) interface 1400.

The processor 1100 may be implemented as a central processing unit (CPU), another chipset, or a microprocessor.

The memory 1200 may be implemented as a medium such as random access memory (RAM), a dynamic random access memory (DRAM), a rambus DRAM (RDRAM), a synchronous DRAM (SDRAM), a static RAM (SRAM), etc.

The storage device 1300 may be implemented as a hard disk, an optical disk such as a compact disk read only memory (CD-ROM), a CD rewritable (CD-RW), a digital video disk ROM (DVD-ROM), a DVD-RAM, a DVD-RW disk, Blu-ray disks, etc., a flash memory, or permanent or volatile storage devices such as various types of RAM.

The memory 1200 or the storage device 1300 may store the above-described left image and right image, disparity values of the left image, and disparity values of the right image.

The I/O interface 1400 allows the processor 1100 and/or the memory 1200 to access the storage device 1300. In addition, the I/O interface 1400 may provide an interface with a user. For example, a stereo image may be input through the I/O interface 1400, and an enhanced disparity map may be output through the I/O interface 1400.

The processor 1100 may perform a function of enhancing the disparity map described in FIGS. 1 to 9, may load a program command for implementing at least some function of the stereo matching unit 110 and the disparity enhancing unit 120 in the memory 1200, and may control to perform the operation described with reference to FIGS. 1 to 9. These program commands may be stored in the storage device 1300, or may be stored in another system connected through a network.

According to an embodiment of the present invention, a disparity map may be corrected from the first input image by using a valid disparity value of the near periphery.

In addition, it is possible to enhance the disparity value even when an occluded area occurs due to a limitation of stereo matching and when a corresponding point cannot be found due to a problem in an acquired image.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (08) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for enhancing a disparity map generated by performing stereo matching on a stereo image in an apparatus for enhancing the disparity map, the method comprising:
generating a disparity map of a reference image by performing stereo matching for each stereo image;
dividing the reference image into at least one homogeneous area based on a homogeneity criterion;
extracting valid disparity values from the disparity map of the reference image;
calculating a linear rate of change for the valid disparity values in each homogeneous area divided based on the extracted valid disparity values; and
enhancing the disparity map by updating invalid disparity values in a corresponding homogeneous area using the linear rate of change calculated for each homogeneous area.

2. The method of claim 1, wherein the calculating includes:
a first step of setting a linear rate of change in a first homogeneous area by using valid disparity values in the first homogeneous area, when the number of valid disparity values in the first homogeneous area is greater than a minimum value; and
a second step of setting a linear rate of change in the first homogeneous area by using the valid disparity values of at least one second homogeneous area adjacent to the first homogeneous area, when the number of valid disparity values in the first homogeneous area is less than or equal to the minimum value.

3. The method of claim 2, wherein the first step includes, when there are two or more pixels having a valid disparity value on the same y-axis in the first homogeneous area, calculating the linear rate of change using the two valid disparity values, and
the enhancing includes updating an invalid disparity value existing on a line connecting the coordinates of the two pixels having the valid disparity values using the linear rate of change and the valid disparity values.

4. The method of claim 2, wherein the first step includes, when there is one pixel having a valid disparity value on the same y-axis in the first homogeneous area, calculating the linear rate of change using the valid disparity value of the one pixel and a valid disparity value of a pixel closest to the one pixel, and
the enhancing includes updating an invalid disparity value existing on a line connecting coordinates of two pixels having the valid disparity values using the linear rate of change and the valid disparity value of the one pixel.

5. The method of claim 2, wherein the second step includes,
when two pixels having the same y-axis coordinate value in two second homogeneous areas have a valid pixel value, respectively, and there is one pixel having a valid disparity value in the first homogeneous area: estimating disparity values of two pixels in the first homogeneous area having the same y-axis coordinate value as the two pixels of the two second homogeneous areas using a linear rate of change with respect to the valid pixel values of the two pixels of the two second homogeneous areas; and
calculating a linear rate of change in the first homogeneous area by using the distance between each pixel with the estimated disparity value in the first homogeneous area and the pixel having the valid disparity value in the first homogeneous area.

6. The method of claim 2, wherein the second step includes,
when one pixel has a valid disparity value on the y-axis in one second homogeneous area and one pixel has a valid disparity value in the first homogeneous area: estimating valid disparity values of two pixels of the first homogeneous area having the same y-axis coordinate value as the one pixel in the one second homogeneous area using by using a linear rate of change of the valid disparity value in the one second homogeneous area; and
calculating a linear rate of change in the first homogeneous area by using the distance between each pixel with the estimated disparity value in the first homogeneous area and the pixel having the valid disparity value in the first homogeneous area.

7. The method of claim 5, wherein the enhancing includes updating the invalid disparity values in the first homogeneous area by using a linear rate of change in the first homogeneous area and a valid disparity value in the first homogeneous area.

8. The method of claim 2, wherein the second step includes,
when two pixels having the same y-axis coordinate value in two second homogeneous areas have a valid pixel value, respectively, and there is no pixel having a valid disparity value in the first homogeneous area: estimating disparity values of two pixels in the first homogeneous area having the same y-axis coordinate value with the two pixels of the two second homogeneous areas using a linear rate of change with respect to the valid pixel values of the two pixels of the two second homogeneous areas; and
calculating a linear rate of change in the first homogeneous area by using the estimated disparity values of two pixels in the first homogeneous area.

9. The method of claim 2, wherein the second step includes,
when one pixel has a valid disparity value on the y-axis in one second homogeneous area, and there is no pixel having a valid disparity value in the first homogeneous area: estimating valid disparity values of two pixels of the first homogeneous area having the same y-axis coordinate value as the one pixel in the one second homogeneous area using by using a linear rate of change of the valid disparity value in the one second homogeneous area; and
calculating a linear rate of change in the first homogeneous area by using the estimated disparity values of two pixels in the first homogeneous area.

10. The method of claim 8, wherein the enhancing includes updating an invalid disparity value in the first homogeneous region by using a linear rate of change in the first homogeneous region and a disparity value of two pixels estimated in the first homogeneous region.

11. The method of claim 1, wherein the dividing includes grouping pixels having homogeneity in at least one of brightness, texture, and color of the pixel into the same homogeneous area.

12. The method of claim 1, wherein the enhancing includes, after updating the invalid disparity values for all homogeneous areas in the reference image, smoothing an updated disparity map.

13. An apparatus for enhancing a disparity map generated a stereo image, the apparatus comprising:
a stereo matching unit that performs stereo matching for each input stereo image to generate a disparity map of a reference image; and
a disparity enhancing unit that divides the reference image into at least one homogeneous area based on a homogeneity criterion, extracts valid disparity values from the disparity map of the reference image, and updates invalid disparity values in a corresponding homogeneous area by calculating a linear rate of change for the valid disparity values in each divided homogeneous area.

14. The apparatus of claim 13, wherein the disparity enhancing unit includes a disparity allocator for setting a linear rate of change for valid disparity values of the first homogeneous area by using at least one valid disparity value in the first homogeneous area, or by using the valid disparity values of at least one second homogeneous area adjacent to the first homogeneous area, based on the number of valid disparity values in the first homogeneous area.

15. The apparatus of claim 14, wherein the disparity allocator updates invalid disparity values existing in the first homogeneous area by using the linear rate of change for valid disparity values of the first homogeneous area and the at least one valid disparity value in the first homogeneous area.

16. The apparatus of claim 14, wherein the disparity allocator updates estimating disparity values of two pixels in the first homogeneous area having the same y-axis coordinate value as at least one pixel having a valid disparity value of the second homogeneous areas using a linear rate of change with respect to the at least one valid pixel value of the second homogeneous areas, and calculates a linear rate of change in the first homogeneous area by using the estimated disparity values of two pixels in the first homogeneous area.

17. The apparatus of claim 16, wherein when there is one pixel having a valid disparity value in the first homogeneous area, the disparity allocator calculates the linear rate of change in the first homogeneous area by using the estimated disparity values of two pixels in the first homogeneous area and the valid disparity value of the one pixel of the first homogeneous area.

18. The apparatus of claim 16, wherein the disparity allocator updates the invalid disparity values in the first homogeneous area by using the linear rate of change in the first homogeneous area and the estimated disparity values of two pixels in the first homogeneous area.

19. The apparatus of claim 13, wherein the disparity enhancing unit smooths an updated disparity map after updating the invalid disparity values for all homogeneous areas in the reference image.

20. The apparatus of claim 13, wherein the disparity enhancing unit includes an image divider for grouping pixels having homogeneity in at least one of brightness, texture, and color of the pixel into the same homogeneous area.
